(19) United States
(12) Patent Application Publication
(10) Pub. No.: US 2026/0288129 A1
(43) Pub. Date: Sep. 24, 2026

(54) INFORMATION PROCESSING APPARATUS

(71) Applicant: NEC Corporation, Tokyo (JP)

(72) Inventors: Ryosuke TAKAYAMA, Tokyo (JP); Masanao NATSUMEDA, Tokyo (JP)

(73) Assignee: NEC Corporation, Tokyo (JP)

(21) Appl. No.: 19/557,823

(22) Filed: Mar. 5, 2026

(30) Foreign Application Priority Data
Mar. 18, 2025 (JP) 2025-043311

(51) Int. Cl. G05B 23/02

(52) U.S. Cl. CPC G05B 23/0243

(57) ABSTRACT

An information processing apparatus of the present disclosure includes: a determining unit that determines, based on an operational condition of equipment and a state of the equipment, operation details of the equipment satisfying the operational condition; and an evaluating unit that evaluates the equipment based on a prediction of anomaly of the equipment and a prediction of performance of the equipment, both the predictions being based on the operation details.

### INCORPORATION BY REFERENCE

This application is based upon and claims the benefit of priority from Japanese patent application No. 2025-043311, filed on Mar. 18, 2025, the disclosure of which is incorporated herein in its entirety by reference.

### TECHNICAL FIELD

The present disclosure relates to an information processing apparatus.

### BACKGROUND ART

In management of equipment installed in a factory and the like, it is necessary to plan and implement measures such as replacement and maintenance against efficiency reduction and failure occurrence that may occur in the future. Therefore, measures for equipment are being simulated. For example, in Patent Literature 1, procedures and costs are evaluated by simulation based on the failure and performance of equipment.
Patent Literature 1: Japanese Unexamined Patent Application Publication No. JP-A 2014-186503

### SUMMARY

However, the technique of Patent Literature 1 only involves simulation based on the failure and performance of equipment and does not consider the operating state of equipment. Therefore, there arises a problem that it is not possible to properly evaluate equipment through simulations.

Accordingly, an object of the present disclosure is to solve the abovementioned problem that it is not possible to properly evaluate equipment through simulations.

An information processing apparatus as an aspect of the present disclosure includes: a determining unit configured to determine, based on an operational condition of equipment and a state of the equipment, operation details of the equipment satisfying the operational condition; and an evaluating unit configured to evaluate the equipment based on a prediction of anomaly of the equipment and a prediction of performance of the equipment, both the predictions being based on the operation details.

Further, an information processing method as an aspect of the present disclosure is a method by an information processing apparatus, and includes: determining, based on an operational condition of equipment and a state of the equipment, operation details of the equipment satisfying the operational condition; and evaluating the equipment based on a prediction of anomaly of the equipment and a prediction of performance of the equipment, both the predictions being based on the operation details.

Further, a program as an aspect of the present disclosure includes instructions for causing an information processing apparatus to execute processes to: determine, based on an operational condition of equipment and a state of the equipment, operation details of the equipment satisfying the operational condition; and evaluate the equipment based on a prediction of anomaly of the equipment and a prediction of performance of the equipment, both the predictions being based on the operation details.

With the configurations as described above of the present disclosure, it is possible to properly evaluate equipment through simulations.

### BRIEF DESCRIPTION OF THE DRAWINGS

FIG. 1 is a block diagram showing an example of a configuration of an information processing apparatus according to the present disclosure;

FIG. 2 is a block diagram showing an example of a configuration of the information processing apparatus according to the present disclosure;

FIG. 3 is a flowchart showing an example of processing operation by the information processing apparatus according to the present disclosure;

FIG. 4 is a flowchart showing an example of processing operation by the information processing apparatus according to the present disclosure;

FIG. 5 is a flowchart showing an example of processing operation by the information processing apparatus according to the present disclosure;

FIG. 6 is a diagram showing an example of data related to the present disclosure;

FIG. 7 is a diagram showing an example of data related to the present disclosure;

FIG. 8 is a diagram showing an example of data related to the present disclosure;

FIG. 9 is a diagram showing an example of data related to the present disclosure;

FIG. 10 is a block diagram showing an example of a hardware configuration of an information processing apparatus according to the present disclosure;

FIG. 11 is a block diagram showing an example of a configuration of the information processing apparatus according to the present disclosure; and

FIG. 12 is a flowchart showing an example of processing operation by the information processing apparatus according to the present disclosure.

### EXAMPLE EMBODIMENT

### First Example Embodiment

A first example embodiment of the present disclosure will be described with reference to the drawings. The drawings may be related to any of example embodiments.

An information processing apparatus 10 in the present disclosure is, as an example, used to manage equipment installed in a factory and the like. To be specific, the information processing apparatus 10 is configured to simulate the anomaly and performance of running equipment and evaluate evaluation indexes such as measures for the equipment and cost. Herein, equipment is a device for manufacturing a predetermined product, and there are multiple pieces of equipment. However, equipment is not limited to generating a product, and may be equipment for executing a predetermined process on a target object or executing information processing, or may be any device.

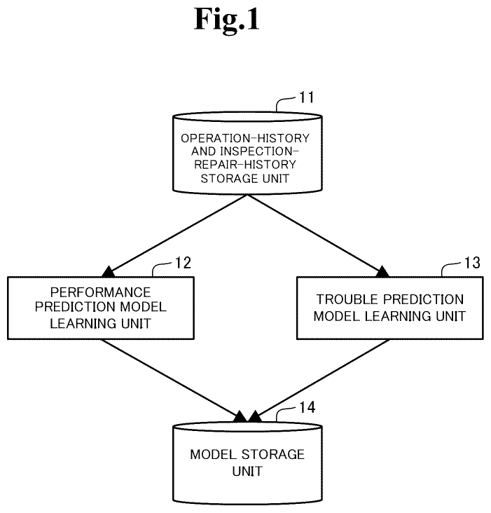

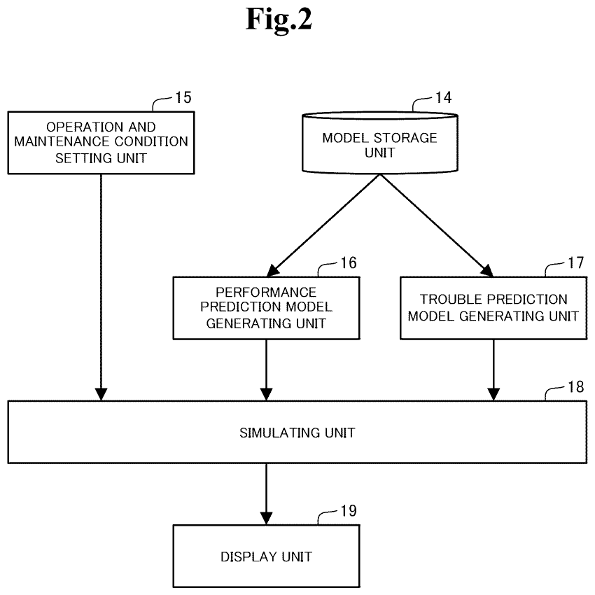

Below, an example of the configuration and operation of the information processing apparatus 10 in this example embodiment will be described. The information processing apparatus 10 is configured with one or a plurality of information processing apparatuses each including an arithmetic logic unit and a memory unit. Then, as shown in FIG. 1, the information processing apparatus 10 includes an operation-history and inspection-repair-history storage unit 11, a performance prediction model learning unit 12, a trouble prediction model learning unit 13, and a model storage unit 14. Further, as shown in FIG. 2, the information processing apparatus 10 includes an operation and maintenance condition setting unit 15, a performance prediction model generating unit 16, a trouble prediction model generating unit 17, a simulating unit 18, and a display unit 19. The respective functions of the performance prediction model learning unit 12, the trouble prediction model learning unit 13, the operation and maintenance condition setting unit 15, the performance prediction model generating unit 16, the trouble prediction model generating unit 17, the simulating unit 18, and the display unit 19 can be implemented by execution of a program for implementing the respective functions stored in the memory unit by the arithmetic logic unit. Further, the operation-history and inspection-repair-history storage unit 11, and the model storage unit 14 can be implemented by the memory unit.

Of the configuration of the information processing apparatus 10 described above, first, a configuration shown in FIG. 1 that performs machine learning will be described.

The operation-history and inspection-repair-history storage unit 11 stores past operation history information and inspection repair history information of equipment. The operation history information (history information on operation) is a history of performance values during operation for each piece of equipment, such as information representing an operation history representing the value of a predetermined performance index with respect to an operation time. At this time, a performance index is, for example, power consumption and yield rate in manufacturing products by equipment. The inspection repair history information (history information of inspection and repair) is a history of inspections and repairs for each piece of equipment, such as information representing a history of inspections and repairs due to anomaly and trouble with respect to an operation time.

The performance prediction model learning unit 12 performs machine learning on a performance prediction model for predicting the performance of equipment, using the abovementioned operation history information and inspection repair history information. For example, the performance prediction model learning unit 12 performs machine learning on a performance prediction model for predicting a performance index from an operation time, using the operation time as an explanatory variable and the performance index as an objective variable. Then, the performance prediction model learning unit 12 stores the trained performance prediction model in the model storage unit 14.

Here, an example of the performance prediction model will be described. The performance prediction model is created by applying a Gaussian process regression model to an operation history and then approximating it by another parametric model. At this time, the kernel used is the sum of a kernel related to an operation time t (first kernel) and a kernel related to the other variable x (second kernel). At this time, the mean f(t, x) of Gaussian regression model outputs can be expressed in the form of the sum of a function of time t and a function of variable x as shown in Formula 1 below.

$$f ( t , x ) = g ( t ) + h ( x ) \qquad [ Formula 1 ]$$

Note that what can be directly calculated is f(t, x).

Then, the curve when the variable x is fixed to a reference value x_{b} is expressed as Formula 2, and the amount of change when the variable x is changed from the reference value is expressed as Formula 3, and appropriate parametric models (e.g., n^{th} order function) are selected for g(t) and h(x), respectively, and regression is performed. Then, each parameter is stored. At least g(t) is approximated by the parametric model, and h(x) may not necessarily be approximated. In a case where h(x) is not approximated by the parametric model, the following Formula 3 may be used as it is.

$$g ( t ) = f ( t , {x}_{b} ) \qquad [ Formula 2 ]$$

$$h ( x ) = f ( 0 , x ) - g ( 0 ) \qquad [ Formula 3 ]$$

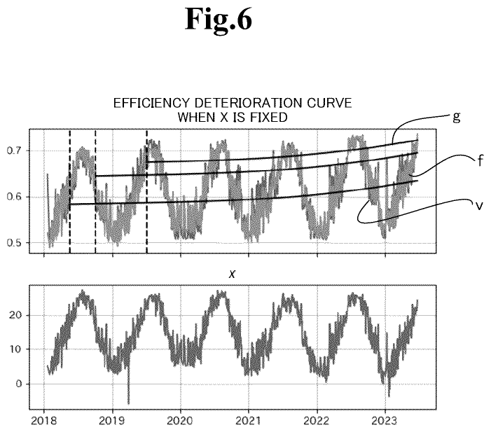

Here, as an example, a reference sign g in the upper view of FIG. 6 denotes a function g(t) of time t, and a reference sign f denotes f(t, x), that is, a prediction value of the operation history. A reference sign v denotes the actual measured value of the operation history. Further, the lower view of FIG. 6 shows an actual measured value when temperature is set to variable x as an example. In this manner, by expressing the performance prediction model by the sum of the function of time t and the function of variable x, it is possible to separate deterioration due to operation from other influences.

Thus, compared to the Gaussian process regression that requires referencing all the data during prediction, the performance prediction model is approximated by a parametric model, so that it is sufficient to hold only the parameters, which leads to lighter weight and faster speeds. In addition, while the Gaussian process regression can express various curves, it is possible to perform regression more accurately than using only a parametric model determined from the beginning. Then, a specific function form is defined as a constraint condition at the time of approximation, so that it is possible to prevent significantly erroneous simulation results.

The trouble prediction model learning unit 13 performs machine learning on a trouble prediction model for predicting the occurrence of trouble (anomaly) of equipment, using the abovementioned operation history information and inspection repair history information. For example, the trouble prediction model learning unit 13 performs machine learning on a trouble prediction model for predicting the occurrence or occurrence probability of trouble from the operation time, using the operation time as an explanatory variable and the occurrence or occurrence probability of trouble as an objective variable. Then, the trouble prediction model learning unit 13 stores the trained trouble prediction model into the model storage unit 14.

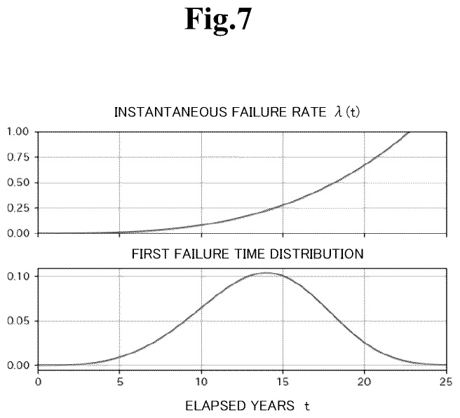

Here, an example of the trouble prediction model will be described. The trouble prediction model is obtained by assuming the Weibull process, and as shown in FIG. 7, modeling the time distribution until an anomaly occurs or the occurrence probability in equipment. For example, as the Weibull process, it is assumed that the failure rate increases gradually as the operation time t increases, and the trouble prediction model is generated by determining a parameter in such a manner as to maximize the degree of likelihood with respect to an inspection repair history.

However, the trouble prediction model is not necessarily limited to using the operation time as an explanatory variable, and a hierarchical model may be used that calculates a parameter from equipment basic information representing the attributes and characteristics of equipment such as equipment types. For example, the hierarchical model may be configured in such a manner as to first calculate the parameter of the Weibull process from equipment basic information such as equipment types in layer 1 and calculate failure probability and time distribution from the Weibull process model in layer 2.

Next, of the abovementioned configuration of the information processing apparatus, a configuration shown in FIG. 2 constructed to simulate and evaluate anomaly and performance of equipment using the respective models will be described.

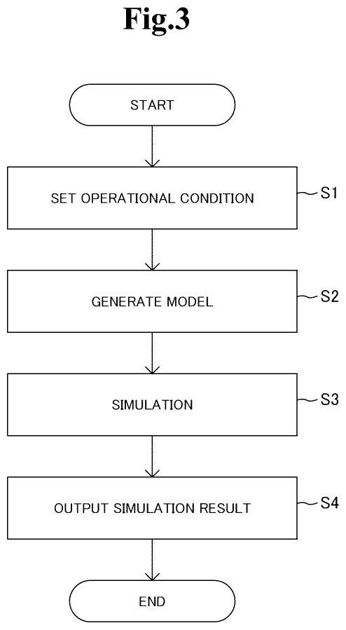

The operation and maintenance condition setting unit 15 sets the operational condition of equipment (step S1 in FIG. 3). As an example of the operational condition, in order that the total production volume by equipment during a relevant period (the sum of production amounts by the operating pieces of equipment) becomes equal to or greater than a specified value determined in advance, the following content is set: among the operable pieces of equipment, those with the best performance indexes are set to be operational in order, and when the total production volume by the operational pieces of equipment exceeds the specified value, the remaining operable pieces of equipment are set to be nonoperational. In the following, an example of a specific process corresponding to the operational condition set here will be described. However, the operational condition may be of any content.

The performance prediction model generating unit 16 retrieves the performance prediction model trained by machine learning from the model storage unit 14 and generates the model. Further, the trouble prediction model generating unit 17 retrieves the trouble prediction model trained by machine learning from the model storage unit 14 and generates the model (step S2 in FIG. 3).

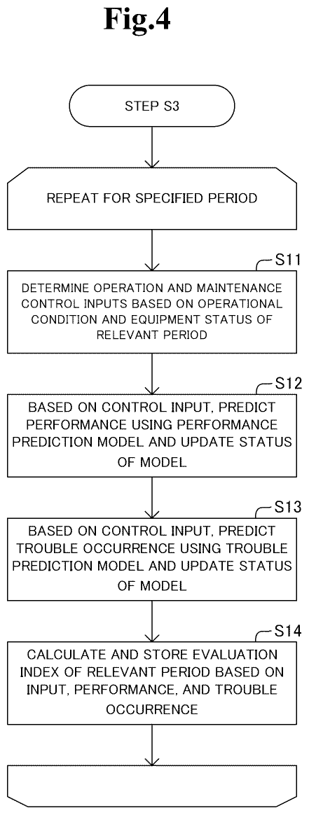

The simulating unit 18 (determining unit, evaluating unit) simulates the anomaly and performance of equipment (step S3 in FIG. 3). The details of the simulation will be described with reference to the flowchart of FIG. 4. As shown in the flowchart of FIG. 4, the simulation is repeatedly performed for a preset period.

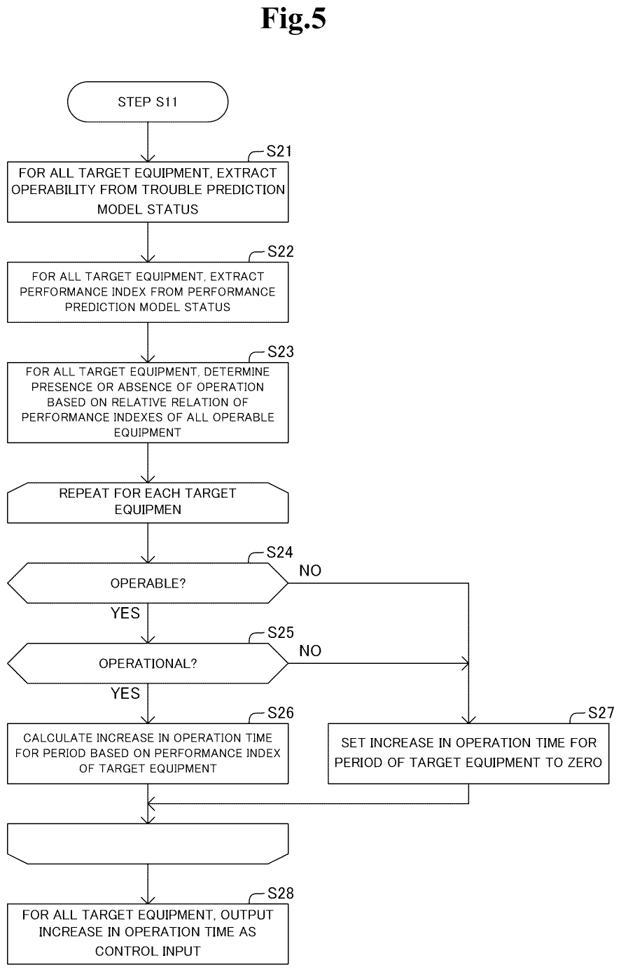

First, the simulating unit 18 determines a control input that is the operation content of equipment satisfying the operational condition based on the operational condition and the state of equipment (step S11 in FIG. 4). Here, the state of equipment refers to a set of information that can be acquired on the equipment, and includes the cumulative operating time of equipment, the presence or absence of occurrence of trouble in the previous period, and the performance index. The presence or absence of occurrence of trouble is calculated based on prediction by the trouble prediction model, and the performance index is calculated based on the result of the performance prediction model. At this time, the simulating unit 18 determines, among the plurality of pieces of equipment, the pieces of equipment to operate and the operating time as control inputs. Furthermore, a determination process on the control inputs by the simulating unit 18 will be described with reference to the flowchart of FIG. 5.

The simulating unit 18 extracts the operability of a piece of equipment from the state of the piece of equipment with respect to all the target pieces of equipment (step S21 in FIG. 5). At this time, the simulating unit 18 extracts the operability of a piece of equipment based on the presence or absence of occurrence of trouble predicted by the trouble prediction model during the previous period. For example, a piece of equipment that is out of order is considered inoperable, and the others are considered operable. Next, the simulating unit 18 extracts the value of the performance index of a piece of equipment from the state of the piece of equipment with respect to all the operable pieces of equipment (step S22 in FIG. 5). At this time, the simulating unit 18 extracts the value of the performance index from the prediction of the performance prediction model during the previous period, for example.

Then, the simulating unit 18 determines whether to be operational or nonoperational with respect to all the operable pieces of equipment based on the relative relation of the performance indexes of all the operable pieces of equipment (step S23 in FIG. 5). At this time, the simulating unit 18 determines whether to be operational or nonoperational and the operational time with respect to each of the target pieces of equipment in accordance with the set operational condition. For example, in this example embodiment, the simulating unit 18 sets, among the operable pieces of equipment, those with the best performance indexes in order to be operational (YES at step S24 and YES at step S25 in FIG. 5). Then, the simulating unit 18 calculates an increase in the operating time during the corresponding period based on the performance indexes of the target pieces of equipment (step S26 in FIG. 5). For example, the simulating unit 18 increases the operating time of a piece of equipment as the performance index thereof is better, or when the performance index exceeds a reference value, uniformly increases the operating time. At the time when the sum of production amounts of the operational pieces of equipment exceeds a specified value, the simulating unit 18 sets the remaining operable pieces of equipment to be nonoperational in accordance with the operating condition (NO at step S25 in FIG. 5). Then, the simulating unit 18 sets an increase in operating time to 0 (step S27 in FIG. 5) with respect to a piece of equipment determined to be inoperable (NO at step S24 in FIG. 5) and determined to be nonoperational (NO at step S25 in FIG. 5) as described above.

The simulating unit 18 determines, for all the pieces of equipment, whether to be operational or nonoperational and the operation time as described above. Then, the simulating unit 18 outputs whether to be operational or nonoperational and the operation time determined for each piece of equipment as the control input (step S28 in FIG. 5).

After that, the simulating unit 18 predicts the performance of the equipment using the performance prediction model based on the determined control input (step S12 in FIG. 4). At this time, the state of performance of the equipment predicted by the performance prediction model is updated and stored. Moreover, the simulating unit 18 predicts a trouble occurrence probability of the equipment using the trouble prediction model based on the determined control input, and predicts the occurrence of trouble of the equipment using a random number based on the probability (step S13 in FIG. 4). Alternatively, the simulating unit 18 may directly predict the occurrence of trouble of the equipment using the trouble prediction model. At this time, the trouble occurrence state of the equipment predicted by the trouble prediction model is updated and stored. These stored performance and trouble states of the equipment may be used as the states of the equipment in the next period.

Then, the simulating unit 18 evaluates by calculating the evaluation index of equipment based on the predictions of equipment performance and trouble occurrence (step S14 in FIG. 4). For example, the simulating unit 18 may calculate the cost of maintenance and use of equipment each year over the next several years as a preset simulation target period, using a calculation formula prepared in advance in accordance with the prediction values of performance and trouble occurrence, as the evaluation indexes, or may alternatively calculate the number of days of occurrence of operation stop due to trouble and insufficient performance due to performance deterioration, as the evaluation indexes.

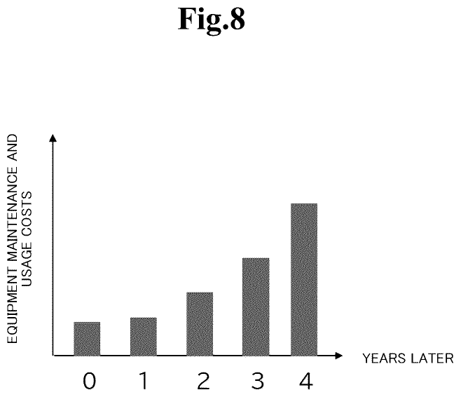

The display unit 19 outputs the evaluation result calculated through the simulation as described above to the display unit of the information processing apparatus 10 or another information processing terminal in such a manner that the user such as an equipment manager can view it (step S4 in FIG. 3). For example, as shown in FIG. 8, the display unit 19 outputs the cost of equipment maintenance and utilization of each year in several years.

As described above, according to the present disclosure, first, the content of operation of equipment is determined from the operational condition and the state of the equipment. Then, predictions of anomaly and performance of the equipment are performed based on the operation content, and evaluation of the cost and so forth for the equipment is performed based on the predictions of anomaly and performance. In this manner, the anomaly and performance are predicted and evaluation is performed in consideration of the operational content of the equipment, it is possible to properly evaluate the equipment.

Further, in the present disclosure, by using the trouble prediction model and the performance prediction model to use a prediction on performance and a prediction on trouble simultaneously for simulation, one of the predictions is affected by the other prediction, resulting in an appropriate simulation. An example in which the output of the trouble prediction model affects the performance prediction model includes influences in the following sequence: “Trouble occurs->Equipment stops->The equipment is not used during downtime, so its performance does not deteriorate”, and “The trouble occurrence probability increases->Repairs or cleaning are performed before trouble occurs->Performance slightly recovers”. Further, an example in which the output of the performance prediction model affects the trouble prediction model includes influences in the following sequence: “Performance deterioration in a certain piece of equipment during a simulation for multiple pieces of equipment,->use frequency decreases because of (relatively) low performance->less likely to cause trouble” and “significant deterioration in performance->cleaning or repairs->trouble occurrence probability decreases”. Therefore, a simulation corresponding to an actual state becomes possible, and it is possible to appropriately evaluate the equipment.

### Second Example Embodiment

Next, a second example embodiment of the present disclosure will be described with reference to the drawings. The drawings may be related to any of the example embodiments.

The information processing apparatus 10 in this example embodiment includes the same configuration as in the first example embodiment described above. In addition to this, the information processing apparatus 10 includes the following configuration. Hereinafter, a configuration different from the above will be mainly described.

In this example embodiment, the variables t of the performance prediction model and the trouble prediction model may not be an operation time. For example, the variable t may be a variable corresponding to the lapse of time, such as an elapsed time from installation of equipment including aa non-operation time or the number of times equipment is used. Moreover, it is sufficient that the reference (installation date, start date, etc.) and the scale (year, day, hour, etc.) are the same during model learning and prediction.

### Third Example Embodiment

Next, a third example embodiment of the present disclosure will be described with reference to the drawings. The drawings may be related to any of the example embodiments.

The information processing apparatus 10 in this example embodiment includes the same configuration as in the first and second example embodiments described above. Then, in this example embodiment, a case of simulating an evaluation targeted for factory air-conditioning equipment (a plurality of turbo freezers) is shown.

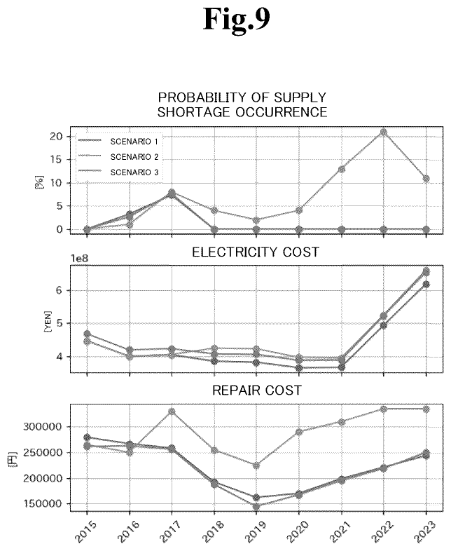

First, the plurality of freezers have a difference in trouble occurrence rate and performance deterioration due to a difference in types, installation days, and so forth. A model is trained using actual data of the plurality of freezers, and the simulation is performed using several operation and maintenance scenarios (presence or absence of new equipment introduction, etc.). Consequently, it becomes possible to compare important indexes such as cost and performance shortage occurrence rate as shown in FIG. 9.

### Fourth Example Embodiment

Next, a fourth example embodiment of the present disclosure will be described with reference to the drawings. This example embodiment shows the overview of the information processing apparatus and so forth described in the above example embodiment. The drawings may be related to any of the example embodiments.

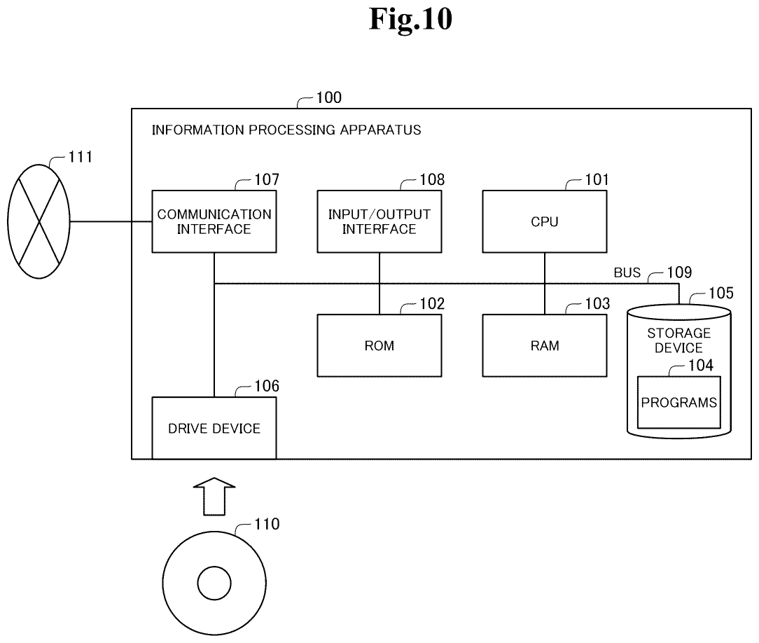

First, a hardware configuration of an information processing apparatus 100 in the present disclosure will be described. The information processing apparatus 100 is configured with a general information processing apparatus, and as an example, as shown in FIG. 10, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 10 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

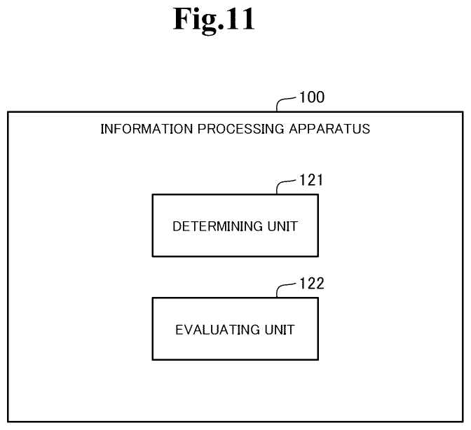

Then, the information processing apparatus 100 can construct and include a determining unit 121 and an evaluating unit 122 shown in FIG. 11 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the abovementioned determining unit 121 and evaluating unit 122 may be constructed using dedicated electronic circuits for implementing such means.

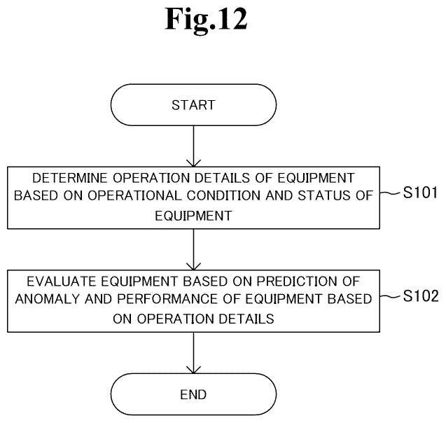

The determining unit 121 determines, based on an operational condition by equipment and a state of the equipment, operation details of the equipment satisfying the operational condition (step S101 in FIG. 12). The evaluating unit 122 evaluates the equipment based on a prediction of an anomaly of the equipment and a prediction of performance of the equipment based on the operation details (step S102 in FIG. 12).

In the above configuration, the information processing apparatus 100 first determines the operation details of equipment based on the operational condition and the state of the equipment. Then, predictions of anomaly and performance of the equipment are performed based on the operation details, and an evaluation of cost and so forth of the equipment is performed based on the predictions of anomaly and performance. In this manner, the evaluation is performed by predicting anomaly and performance in consideration of the operation details of the equipment, so that it is possible to properly evaluate the equipment.

At least one or more of the functions of the determining unit 121 and the evaluating unit 122 described above may be executed by an information processing apparatus installed and connected anywhere on the network, that is, may be executed by so-called cloud computing.

Further, the abovementioned program can be stored using various types of non-transitory computer-readable mediums and provided to a computer. The non-transitory computer-readable mediums include various types of tangible storage mediums. Examples of the non-transitory computer-readable mediums include magnetic recording medium (e.g., flexible disk, magnetic tape, hard disk drive), magneto-optical recording medium (e.g., magneto-optical disk), CD-ROM (Read Only Memory), CD-R, CD-R/W, and semiconductor memory (e.g., mask ROM, PROM (Programmable ROM), EPROM (Erasable PROM), flash ROM, RAM (Random Access Memory (RAM)). In addition, the program may be provided to a computer by various types of transitory computer-readable mediums. Examples of the transitory computer-readable mediums include electrical signals, optical signals, and electromagnetic waves. The transitory computer-readable mediums may provide the program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configuration described in Supplementary Notes below.

All or some of the configurations described in Supplementary Notes 2 to 8 dependent on Supplementary Note 1 below and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, some or all of the configurations described in Supplementary Notes and the functions by such configurations may be dependent on hardware, software, various recording means for recording software, or system.

### (Supplementary Note 1)

An information processing apparatus comprising:
a determining unit configured to determine, based on an operational condition of equipment and a state of the equipment, operation details of the equipment satisfying the operational condition; and
an evaluating unit configured to evaluate the equipment based on a prediction of anomaly of the equipment and a prediction of performance of the equipment, both the predictions being based on the operation details.

### (Supplementary Note 2)

The information processing apparatus according to supplementary note 1, wherein
the determining unit is configured to determine the operation details including whether the equipment is operational or nonoperational based on the operational condition and the state of the equipment.

### (Supplementary Note 3)

The information processing apparatus according to supplementary note 2, wherein
the determining unit is configured to determine the operation details including the operating equipment and the operating time of the equipment based on the operational condition and the state of the equipment.

### (Supplementary Note 4)

The information processing apparatus according to supplementary note 1, wherein
the determining unit is configured to determine the operation details of the equipment based on the operational condition of the equipment and the state of the equipment, the state being the anomaly and the performance of the equipment.

### (Supplementary Note 5)

The information processing apparatus according to supplementary note 4, wherein
the determining unit is configured to determine the operation details in such a manner that operation starts from the equipment with the good performance based on the state of the equipment, the state being the performance.

### (Supplementary Note 6)

The information processing apparatus according to supplementary note 1, wherein
the evaluating unit is configured to perform the prediction of the anomaly of the equipment based on the operation details of the equipment using an anomaly prediction model, perform the prediction of the performance of the equipment based on the operation details of the equipment using a performance prediction model, and evaluate an operation state of the equipment based on the prediction of the anomaly of the equipment and the prediction of the performance of the equipment.

### (Supplementary Note 7)

The information processing apparatus according to supplementary note 6, wherein
the performance prediction model is a model obtained by Gaussian process regression on operation history information of the equipment using a sum of a first kernel over a variable corresponding to a lapse of time and a second kernel over another variable as a kernel, at least a function corresponding to the lapse of time in the model being approximated by a parametric model.

### (Supplementary Note 8)

The information processing apparatus according to supplementary note 6, wherein
the anomaly prediction model is a Weibull process model obtained by calculating a parameter so as to maximize a degree of likelihood with respect to inspection and repair history information of the equipment.

### (Supplementary Note 9)

An information processing method by an information processing apparatus, the information processing method comprising:
determining, based on an operational condition of equipment and a state of the equipment, operation details of the equipment satisfying the operational condition; and
evaluating the equipment based on a prediction of anomaly of the equipment and a prediction of performance of the equipment, both the predictions being based on the operation details.

### (Supplementary Note 10)

A program comprising instructions for causing an information processing apparatus to execute processes to:
determine, based on an operational condition of equipment and a state of the equipment, operation details of the equipment satisfying the operational condition; and
evaluate the equipment based on a prediction of anomaly of the equipment and a prediction of performance of the equipment, both the predictions being based on the operation details.

### REFERENCE SIGNS LIST

11 operation-history and inspection-repair-history storage unit
12 performance prediction model learning unit
13 trouble prediction model learning unit
14 model storage unit
15 operation and maintenance condition setting unit
16 performance prediction model generating unit
17 trouble prediction model generating unit
18 simulating unit
19 display unit
100 information processing apparatus
101 CPU
102 ROM
103 RAM
104 programs
105 storage device
106 drive device
107 communication interface
108 input/output interface
109 bus
110 storage medium
111 communication network
121 determining unit
122 evaluating unit

1. An information processing apparatus comprising:
at least one memory storing processing instructions; and
at least one processor configured to execute the processing instructions, wherein the at least one processor is configured to execute the processing instructions to:
determine, based on an operational condition of equipment and a state of the equipment, operation details of the equipment satisfying the operational condition; and
evaluate the equipment based on a prediction of anomaly of the equipment and a prediction of performance of the equipment, both the predictions being based on the operation details.

2. The information processing apparatus according to claim 1, wherein the at least one processor is configured to execute the processing instructions to
determine the operation details including whether the equipment is operational or nonoperational based on the operational condition and the state of the equipment.

3. The information processing apparatus according to claim 2, wherein the at least one processor is configured to execute the processing instructions to
determine the operation details including the operating equipment and the operating time of the equipment based on the operational condition and the state of the equipment.

4. The information processing apparatus according to claim 1, wherein the at least one processor is configured to execute the processing instructions to
determine the operation details of the equipment based on the operational condition of the equipment and the state of the equipment, the state being the anomaly and the performance of the equipment.

5. The information processing apparatus according to claim 4, wherein the at least one processor is configured to execute the processing instructions to
determine the operation details in such a manner that operation starts from the equipment with the good performance based on the state of the equipment, the state being the performance.

6. The information processing apparatus according to claim 1, wherein the at least one processor is configured to execute the processing instructions to
perform the prediction of the anomaly of the equipment based on the operation details of the equipment using an anomaly prediction model, perform the prediction of the performance of the equipment based on the operation details of the equipment using a performance prediction model, and evaluate an operation state of the equipment based on the prediction of the anomaly of the equipment and the prediction of the performance of the equipment.

7. The information processing apparatus according to claim 6, wherein
the performance prediction model is a model obtained by Gaussian process regression on operation history information of the equipment using a sum of a first kernel over a variable corresponding to a lapse of time and a second kernel over another variable as a kernel, at least a function corresponding to the lapse of time in the model being approximated by a parametric model.

8. The information processing apparatus according to claim 6, wherein
the anomaly prediction model is a Weibull process model obtained by calculating a parameter so as to maximize a degree of likelihood with respect to inspection and repair history information of the equipment.

9. An information processing method by an information processing apparatus, the information processing method comprising:
determining, based on an operational condition of equipment and a state of the equipment, operation details of the equipment satisfying the operational condition; and
evaluating the equipment based on a prediction of anomaly of the equipment and a prediction of performance of the equipment, both the predictions being based on the operation details.

10. The information processing method according to claim 9, comprising
determining the operation details including whether the equipment is operational or nonoperational based on the operational condition and the state of the equipment.

11. The information processing method according to claim 10, comprising
determining the operation details including the operating equipment and the operating time of the equipment based on the operational condition and the state of the equipment.

12. The information processing method according to claim 9, comprising
determining the operation details of the equipment based on the operational condition of the equipment and the state of the equipment, the state being the anomaly and the performance of the equipment.

13. The information processing method according to claim 12, comprising
determining the operation details in such a manner that operation starts from the equipment with the good performance based on the state of the equipment, the state being the performance.

14. The information processing method according to claim 9, comprising
performing the prediction of the anomaly of the equipment based on the operation details of the equipment using an anomaly prediction model, performing the prediction of the performance of the equipment based on the operation details of the equipment using a performance prediction model, and evaluating an operation state of the equipment based on the prediction of the anomaly of the equipment and the prediction of the performance of the equipment.

15. A non-transitory computer-readable storage medium storing a program, the program comprising instructions for causing an information processing apparatus to execute processes to:
determine, based on an operational condition of equipment and a state of the equipment, operation details of the equipment satisfying the operational condition; and
evaluate the equipment based on a prediction of anomaly of the equipment and a prediction of performance of the equipment, both the predictions being based on the operation details.
